(19) United States
(12) Patent Application Publication
(10) Pub. No.: US 2012/0005630 A1
(43) Pub. Date: Jan. 5, 2012

(54) Highly Responsive Screen Output Device, Screen Output System, and Screen Output Method

(75) Inventors: Akio Ohba, Kanagawa (JP); Hiroyuki Segawa, Kanagawa (JP); Tetsugo Inada, Kanagawa (JP)

(73) Assignee: Sony Computer Entertainment Inc., Tokyo (JP)

(21) Appl. No.: 13/154,788

(22) Filed: Jun. 7, 2011

(30) Foreign Application Priority Data
Jul. 5, 2010 (JP) 2010-153201

(51) Int. Cl. G06F 3/048

(52) U.S. Cl. 715/853

(57) ABSTRACT

An input information acquisition unit in an information processing device acquires information related to a user operation provided in an input device. A screen data generation unit generates data for a basic screen that should be displayed in response to the user operation. A hierarchical data generation unit generates hierarchical data from the data for the basic screen. A frame area determination unit determines a frame area that should be displayed. An updated area determination unit determines an area that should be updated in response to the user operation. A loading unit loads data necessary for display from a hard disk drive. A decoding unit decodes image data. A displayed image processing unit renders a displayed image.

### BACKGROUND OF THE INVENTION

1. Field of the Invention

The present invention relates to image processing technology adapted to enlarge/reduce an image displayed on a display or move the image vertically and horizontally.

2. Description of the Related Art

Recent development in image processing technology and increased availability of networks have enabled acquiring and displaying desired information using a variety of terminals. For example, a technology is proposed capable of displaying desired information in a simple mobile terminal by using a terminal controlled by a user and an information processing device performing actual information processing, which are separated from each other (see, for example, Japanese Patent Application Laid-Open No. 2010-20159).

Efficiency of image display and updating thereof carry weight in order to obtain desired information efficiently via a screen of a display device. As enormous amount of information can be obtained via a network, improvement in response of on-screen display to a user input is called for.

### RELATED ART LIST

JPA laid open 2010-20159

### SUMMARY OF THE INVENTION

The present invention addresses the issue and a general purpose thereof is to provide image processing technology capable of improving response of on-screen display to a user input.

An embodiment of the present invention relates to a screen output device. The screen output device comprises:

an input information acquisition unit configured to acquire information related to a user input provided in an input device; a screen data generation unit configured to generate data for a basic screen in which images that should be displayed in response to the user input are arranged; a hierarchical data generation unit configured to generate hierarchical data formed as hierarchization of a plurality of pieces image data representing the basic screen in a plurality of resolutions and arranged in the order of resolution; and a displayed image processing unit configured to switch between data in the hierarchical data and use the selected data to generate an output screen in accordance with a user input of a type requesting scrolling or enlargement/reduction of the screen, wherein the hierarchical data generation unit updates, when a need arises to update at least part of the basic screen in response to a user input, a relevant area in the hierarchical data.

Another embodiment of the present invention relates to a screen output system. The screen output system comprises a user terminal operated by a user and provided with a display, and an information processing device receiving information on user operation in the user terminal via a network and transmitting image data for a screen that should be displayed on the display to the user terminal, wherein the information processing device comprises: a screen data generation unit configured to generate data for a basic screen in which images that should be displayed in response to the user operation are arranged; and a hierarchical data generation unit configured to generate hierarchical data formed as hierarchization of a plurality of pieces image data representing the basic screen in a plurality of resolutions and arranged in the order of resolution, wherein the user terminal comprises: a data request unit configured to designate, from data blocks forming the hierarchical data, a data block determined in accordance with an area of an output screen changed in response to a request, provided via the operation, to scroll, enlarge, or reduce the screen, and to request relevant image data from the information processing device, and a displayed image processing unit configured to use the image data transmitted from the information processing device in response to the request so as to generate an output screen that is displayed on the display, wherein the hierarchical data generation unit updates, when a need arises to update at least part of the basic screen in response to the operation, a relevant area in the hierarchical data.

Another embodiment of the present invention relates to a screen output method. The screen output method comprises: acquiring information related to a user input provided in an input device; generating data for a basic screen in which images that should be displayed in response to the user input are arranged; generating hierarchical data formed as hierarchization of a plurality of pieces image data representing the basic screen in a plurality of resolutions and arranged in the order of resolution; updating, when a need arises to update at least part of the basic screen in response to a user input, a relevant area in the hierarchical data; and switching between data in the hierarchical data and using the selected data to generate an output screen in accordance with a user input of a type requesting scrolling or enlargement/reduction of the screen,

Another embodiment of the present invention also relates to a screen output method. The screen output method is adapted to a system where an information processing device connected to a network generates image data for a screen in response to a user operation in a user terminal also connected to the network, causing a display of the user terminal to display the screen, the method comprising, in the information processing device: generating data for a basic screen in which images that should be displayed in response to the user operation are arranged; generating hierarchical data formed as hierarchization of a plurality of pieces image data representing the basic screen in a plurality of resolutions and arranged in the order of resolution; and updating, when a need arises to update at least part of the basic screen in response to the operation, a relevant area in the hierarchical data, and the method further comprising, in the user terminal; designating, from data blocks forming the hierarchical data, a data block determined in accordance with an area of an output screen changed in response to a request, provided via the operation, to scroll, enlarge, or reduce the screen, and requesting relevant image data from the information processing device; and using the image data transmitted from the information processing device in response to the request so as to generate an output screen that is displayed on the display.

Optional combinations of the aforementioned constituting elements, and implementations of the invention in the form of methods, apparatuses, systems, and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows an environment in which an image processing system to which the first embodiment can be applied;

FIG. 2 shows the configuration of the image processing device according to the first embodiment;

FIG. 3 schematically shows the hierarchical data generated according to the first embodiment;

FIG. 4 shows a process of prefetching image data according to the first embodiment;

FIG. 5 shows the configuration of the control unit according to the first embodiment in detail;

FIG. 6 shows a method of updating a tile image according to the first embodiment when part of the basic screen is updated;

FIG. 7 is a flowchart showing the steps for displaying a screen according to the first embodiment;

FIG. 8 shows the configuration of an on-screen display system according to the second embodiment;

FIG. 9 shows the configuration of the mobile terminal and the PC according to the second embodiment in detail;

FIG. 10 is a sequence chart showing the steps of displaying a screen according to the second embodiment; and

FIG. 11 is a sequence chart showing the steps of displaying a screen according to the second embodiment.

### DETAILED DESCRIPTION OF THE INVENTION

The invention will now be described by reference to the preferred embodiments. This does not intend to limit the scope of the present invention, but to exemplify the invention.

### First Embodiment

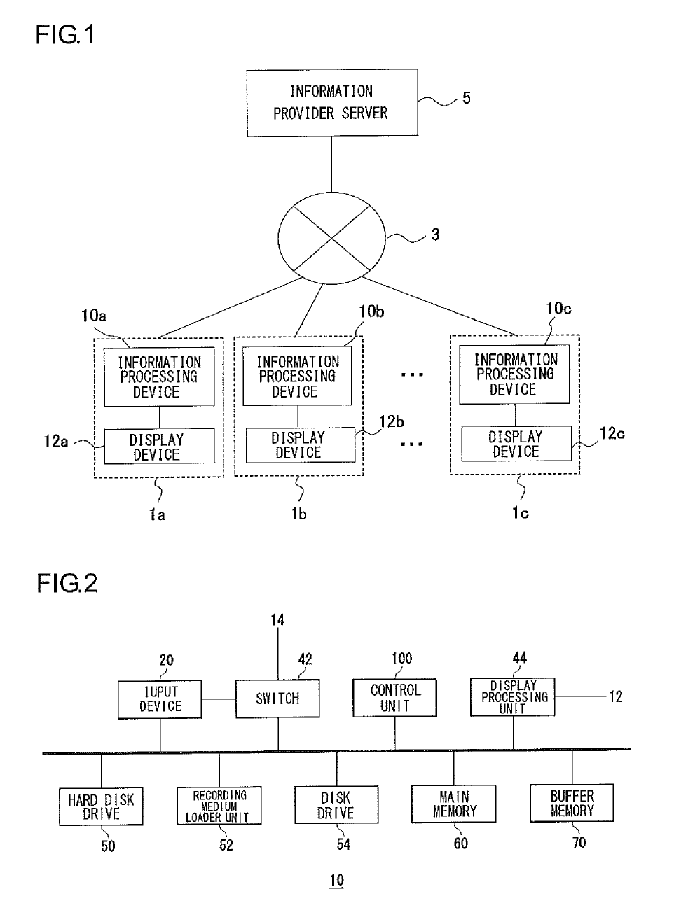

FIG. 1 shows an environment in which an image processing system to which the embodiment can be applied. As shown in the figure, information processing systems 1a, 1b, and 1c are configured to be connected to a network 3 and deliver data between the system and an information provider server 5. In response to a request from the information processing systems 1a, 1b, and 1c, the information provider server 5 transmits data (e.g., web page data) for an image that can be displayed in the requesting information processing systems 1a, 1b, and 1c or information necessary to display the image. The information processing systems 1a, 1b, and 1c are connected to the network 3 using a cable or wirelessly. Ordinary technologies can be employed for connection to the information provider server 5 or for processes related to data request or data reception.

The information processing systems 1a, 1b, and 1c comprise information processing devices 10a, 10b, and 10c, respectively, configured to perform data delivery between the system and the information provider server 5, and comprise display devices 12a, 12b, and 12c, respectively, configured to display results of processing by the information processing devices 10a, 10b, and 10c. The display devices 12a, 12b, and 12c may be a display adapted to output an image or a television set provided with a display and a speaker. In the following description, information processing systems are collectively referred to as an information processing system 1, information processing devices are collectively referred to as an information processing device 10, and display devices are collectively referred to as a display device 12. The display device 12 may be connected to the information processing device 10 using a cable. Alternatively, the device 12 may be wirelessly connected using a wireless local area network (LAN).

The information processing device 10 updates an image to be displayed on the display device 12 in accordance with a request from the user. The information processing device 10 may update the desktop. For example, the content of a new window or a file may be displayed in accordance with an input provided by selection using graphical user interface (GUI) such as a menu image or a thumbnail image of electronic data, or a web page acquired from the information provider server 5 may be displayed.

Therefore, the data for an image to be displayed on the display device 12 may be successively acquired from the information provider server 5 in accordance with a request from the user, or maintained in the information processing device 10 before the request, or may be originated from both sources. In addition, the information processing device 10 scrolls or enlarges/reduces the screen displayed on the display device 12 in accordance with a request from the user. In the following description, update to an image itself displayed in the screen (e.g., desktop) according to user operation will be referred to as “update to basic screen”, which is distinguished from update to a frame area such as scrolling or enlargement/reduction of the screen.

FIG. 2 shows the configuration of the image processing device 10. The image processing device 10 comprises an air input device 20, a switch 42, a display processing unit 44, a hard disk drive 50, a recording medium loader unit 52, a disk drive 54, a main memory 60, a buffer memory 70, and a control unit 100. The display processing unit 44 is provided with a frame memory for buffering data to be displayed on the display of the display device 12.

The input device 20 receives a request provided by the user viewing the screen displayed on the display device 12. For example, the input device 20 receives a request to select a file or a command, or a request to scroll or enlarge/reduce the screen. The input device 20 transfers the request to the control unit 100 as a signal. The input device 20 is implemented by an ordinary input device such as a pointing device, a mouse, a keyboard, a touch panel, a game controller, or a button. The input device 20 and the control unit 100 may establish wireless communication using the Bluetooth (registered trademark) protocol or the IEEE802.11 protocol. The input device 20 may be connected to the control unit 100 using a cable.

The switch 42 is an Ethernet switch (Ethernet is a registered trademark), a device connected to an external device using a cable or wirelessly so as to transmit and receive data. The switch 42 is connected to an external network 3 via a cable 14 so as to receive image data from the information provider server 5.

The hard disk drive 50 functions as a storage device for storing data. When a removable recording medium such as a memory card is mounted, the recording medium loader unit 52 reads data from the removable recording medium. When a read-only ROM disk is mounted, the disk drive 54 drives and recognizes the ROM disk so as to read data. The ROM disk may be an optical disk or a magneto-optical disk. Image data to be displayed on the display device 12, and programs and data required to run processes may be stored in the hard disk drive 50, the removable recording medium, or the ROM disk.

The control unit 100 is provided with a multicore CPU. One general-purpose processor core and a plurality of simple processor cores are provided in a single CPU. The general-purpose processor core is referred to as a power processing unit (PPU) and the other processor cores are referred to as synergistic-processing units (SPU).

The control unit 100 is provided with a memory controller connected to the main memory 60 and the buffer memory 70. The PPU is provided with a register and a main processor as an entity of execution. The PPU efficiently allocates tasks as basic units of processing in applications to the respective SPUs. The PPU itself may execute a task. The SPU is provided with a register, a subprocessor as an entity of execution, and a local memory as a local storage area. The local memory may be used as the buffer memory 70.

The main memory 60 and the buffer memory 70 are storage devices and are formed as random access memories (RAM). The SPU is provided with a dedicated direct memory access (DMA) controller and is capable of high-speed data transfer between the main memory 60 and the buffer memory 70. High-speed data transfer is also achieved between the frame memory in the display processing unit 44 and the buffer memory 70. The control unit 100 according to the first embodiment implements high-speed image processing by operating a plurality of SPUs in parallel. The display processing unit 44 is connected to the display device 12 and outputs a result of image processing in accordance with user request.

The information processing device 10 according to the first embodiment uses image data representing a display screen on the display device 12 and generates hierarchical data comprising a plurality of pieces of image data representing the screen in different resolutions, and stores the generated data in the hard disk drive 50. For enlargement/reduction of the screen according to a user input, the information processing device 10 switches layers of image data used in rendering in accordance with the enlargement/reduction factor. This enables enlargement or reduction and efficient processing irrespective of the content of the image displayed in the screen.

For example, when the display device 12 is embodied by a television in a living room or a projector in a conference hall, the distance between the viewer and the screen is generally larger than in the case of a personal computer (PC). For this reason, viewability comparable to that of PC is normally obtained by enlarging an area of the screen in accordance with the expected distance. Unlike a person viewing a PC display in front, the user viewing a living room television or a projector cannot easily bring his or her face close to an area of interest in the screen. On top of that, there should be constraints on the area of the screen. Therefore, visibility of the same level may not necessarily be obtained.

Accordingly, the first embodiment ensures that a displayed image can be enlarged or reduced as desired and efficiently by generating hierarchical data as described above so that details of an area of interest can be inspected or the perspective of the entirety can be gained regardless of the display environment. The image displayed according to the first embodiment may not only be prepared as a single image but also any screen that can be displayed in an ordinary PC.

More specifically, an input for selecting an icon in the display screen may cause an icon of a file stored in a storage area represented by the selected icon to be displayed, or cause the content of a document file or an image file represented by the selected icon to be displayed. Alternatively, an input to control a web browser in the display screen may cause a desired web page to be displayed. The screen displayed on the display of a PC according to such an operation will be referred to as a “basic screen”.

The information processing device 10 generates hierarchical data for a basic screen. When a part of the basic screen needs to be updated (e.g., when a user input to open a new window is provided), the information processing device 10 updates only the data for a changed area in the hierarchical data of the respective layers. If the entirety of the basic screen is changed, the information processing device 10 updates the entirety of hierarchical data.

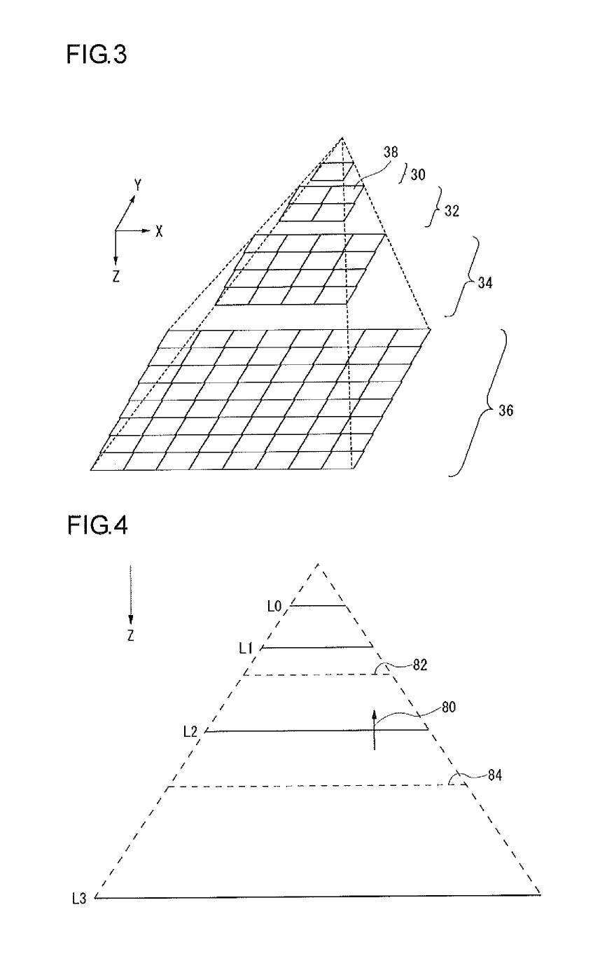

FIG. 3 schematically shows the hierarchical data generated according to the first embodiment. The hierarchical data has a hierarchical structure comprising a 0-th layer 30, a first layer 32, a second layer 34, and a third layer 36 in the direction of depth (Z axis). While the figure only shows four layers, the number of layers is nonrestrictive.

The hierarchical data shown in FIG. 3 has a quadtree hierarchical structure. Each layer comprises one or more tile images 38. All of the tile images 38 are formed to have the same size having the same number of pixels. For example, an image includes 256*256 pixels. The image data in the layers are representations of an image in different resolutions. The resolution grows lower in the following order: the third layer 36, the second layer 34, the first layer 32, and the 0-th layer 30. For example, the resolution in the Nth layer (N is an integer equal to or greater than 0) may be ½ the resolution of the (N+1)th layer in both the horizontal (X axis) direction and the vertical (Y axis) direction.

The hierarchical image data is compressed in a predefined compression format and is stored in the hard disk drive 50 and is read from the hard disk drive 50 and decoded before being displayed on the display device 12. The compression format is nonrestrictive. For example, the S3TC format, JPEG format, or the JPEG2000 format may be used.

The basic image for which hierarchical data is generated may be data for any image that should be displayed in accordance with a user input and nonrestrictive in terms of the type and combination (e.g., a background image of a screen, icon, menu image, web page, text image, still image, moving image). For example, the information processing device 10 may configure the image showing the entirety of the basic screen on the display device as forming the 0-th layer 30. The information processing device 10 may generate the first layer 32, the second layer 34, and the third layer 36 by increasing the resolution in three stages. The scale used in generating hierarchical data is nonrestrictive, and the image may be reduced or enlarged depending on the resolution of an element image.

As shown in FIG. 3, the hierarchical structure of hierarchical data is configured such that the horizontal direction is defined along the X axis, the vertical direction is defined along the Y axis, and the depth direction is defined along the Z axis, thereby building a virtual three-dimensional space. Upon deriving the amount of change in a frame by referring to a signal supplied from the input device 20 and requesting scrolling or enlargement/reduction of the screen, the image processing device 10 uses the amount of change to derive the coordinates at the four corners of the frame (frame coordinates) in the virtual space.

Frame coordinates in the virtual space are used to load compressed data into the main memory 60 (described later) or to render a frame. Moreover, the frame coordinates are used to determine an area defined in the hierarchical data that should be updated preferentially. Instead of the frame coordinates in the virtual space, the image processing device 10 may derive information identifying the layer and the texture coordinates (UV coordinates) in the layer. Hereinafter, the combination of the information identifying the layer and the texture coordinates will also be referred to as frame coordinates.

The image processing device 10 is configured to load part of the hierarchical data from the hard disk drive 50 into the main memory 60 in order to update the display smoothly as the screen is enlarged/reduced or scrolled. Further, the device 10 may prefetch an area that will be displayed in the future and decode part of the image data loaded into the main memory 60 in accordance with the direction of movement of the frame, and store the decoded data in the buffer memory 70. This allows instant switching of images used for frame rendering when the switching is required later.

FIG. 4 shows a prefetch process. FIG. 4 shows the structure of hierarchical data. The layers are represented as L0 (0-th layer), L1 (first layer), L2 (second layer), and L3 (third layer), respectively. In the hierarchical data structure shown in FIG. 4, the position in the depth (Z axis) direction indicates the resolution. The closer to L0, the lower the resolution, and, the closer to L3, the higher the resolution. In terms of the size of the image displayed on the display, the position in the depth direction represents the scale. Assuming that the scale of the displayed image in L3 is 1, the scale in L2 is ¼, the scale in L1 is 1/16, and the scale in L0 is 1/64.

Therefore, if the frame changes in the depth direction away from L0 toward L3, the screen is enlarged. If the frame changes in the direction away from L3 toward L0, the screen is reduced. An arrow 80 indicates that a user input signal requests reduction in the screen and shows that reduction occurs across the scale ¼ (L2). In the image processing device 10, the position of L1, L2, which are made available as tile images, in the direction of depth is defined as the boundary of prefetching in the depth direction. When a user input signal indicates crossing the prefetch boundary, the prefetch process is started.

When the scale of the displayed image is close to L2, the frame is rendered by using the tile image in L2 (second layer). More specifically, the L2 image is used when the scale of the screen displayed is between a switching boundary 82 and a switching boundary 84, the boundary 82 being between the image in L1 and the image in L2, and the boundary 84 being between the image in L2 and the image in L3.

Therefore, when reduction of an image is requested as indicated by an arrow 80, the enlarged version of the image in L2 is turned into a reduced version and displayed. Meanwhile, the information processing device 10 identifies the tile image 38 predicted to be necessary in the future by referring to the user input signal and decodes the identified image. In the example of FIG. 4, when the scale requested by the request to reduce the screen exceeds L2, the information processing device 10 reads the tile image 38 in L1, which is located in the direction of reduction, from the hard disk drive 50 or the main memory 60, decodes the read image, and writes the decoded image in the buffer memory 70.

Described above is a prefetch process in the depth direction. Prefetching in the upward, downward, leftward, or rightward direction in the identical layer is also processed in a similar manner. More specifically, the prefetch boundary is set in the image data loaded in the buffer memory 70 so that, when the display position indicated by the user input signal to scroll the screen exceeds the prefetch boundary, the prefetch process is started.

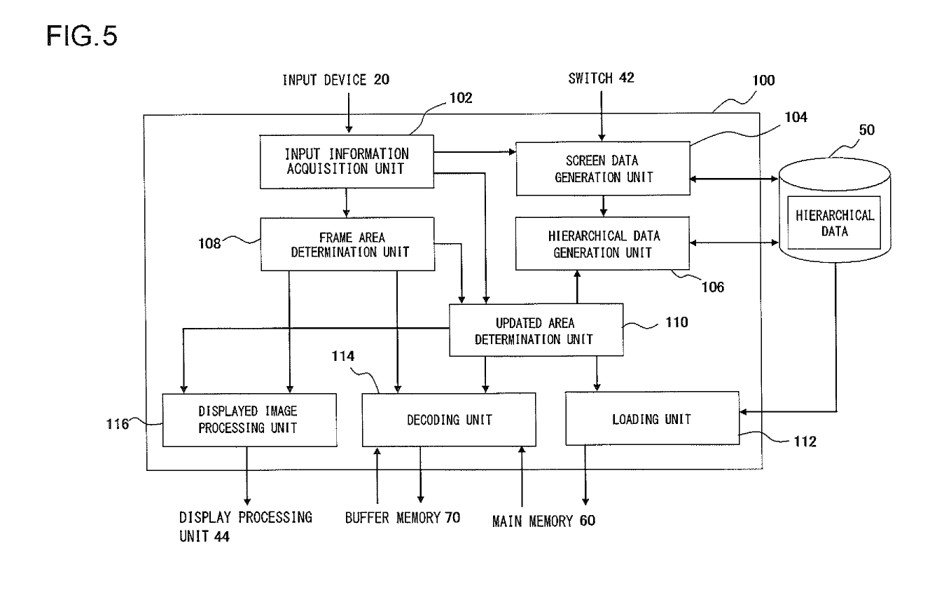

FIG. 5 shows the configuration of the control unit 100 in detail. The figure only shows functional blocks related to image display technology described in the first embodiment. The information processing device 10 may perform processes other than those described above; functional blocks created in association with those processes are omitted from the illustration.

The control unit 100 comprises an input information acquisition unit 102 configured to acquire information related to user operation in the input device 20, a screen data generation unit 104 configured to generate data for a basic screen that should be displayed in accordance with user operation, a hierarchical data generation unit 106 configured to generate hierarchical data from the data for the basic screen, a frame area determination unit 108 configured to successively determine a frame area that should be displayed, an updated area determination unit 110 configured to determine an area in the basic screen that should be updated in accordance with user operation, a loading unit 112 configured to load data necessary for display from the hard disk drive 50, a decoding unit 114 configured to decode image data, and a displayed image processing unit 116 configured to render a displayed image.

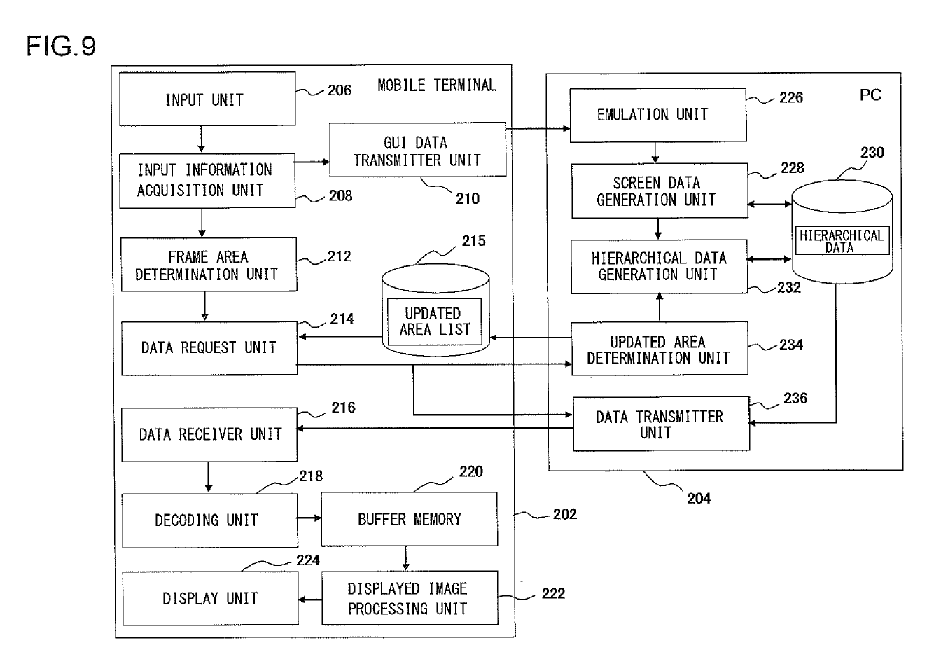

The elements depicted in FIG. 5 and FIG. 9. as functional blocks for performing various processes are implemented in hardware such as a central processing unit (CPU), memory, or other LSI's, and in software such as a programs etc., loaded into the memory. As describe above, the control unit 100 includes one PPU and a plurality of SPUs. The PPU and the SPUs form the functional blocks alone or in combination. Therefore, it will be obvious to those skilled in the art that the functional blocks may be implemented in a variety of manners by hardware only, software only, or a combination of thereof.

The input information acquisition unit 102 acquires, from the input device 20, a command for selection of a file or an application provided by the user via the input device 20, and information related to a user input in the input device 20 for scrolling or enlargement/reduction of the screen. The acquired information is communicated to the screen data generation unit 104, the updated area determination unit 110, and the frame area determination unit 108 as needed.

The screen data generation unit 104 generates data for a basic screen in accordance with the content of user input communicated from the input information acquisition unit 102. The data for individual images forming the basic screen (e.g., a background image, a menu image, an icon image, an image showing a result of running an application, a web page image, etc.) is acquired from the hard disk drive or the information provider server 5 depending on the type of image. The process performed by the screen data generation unit 104 may be similar to the process whereby an ordinary PC generates a display screen. The generated screen data is supplied to the hierarchical data generation unit 106.

When the hierarchical data generation unit 106 acquires the data for the basic screen from the screen data generation unit 104, the hierarchical data generation unit 106 generates hierarchical data by enlarging/reducing the screen to predetermined resolutions. For example, as mentioned above, the basic screen having the resolution of an ordinary display is configured as forming the 0-th layer. Hierarchical data is generated by generating image data enlarged to a predetermined resolution. If the resolution of an original image of an element image included in the basic screen is higher than the resolution of the 0-th layer, a higher-resolution layer is generated by using the data for the original image. The generated hierarchical data is compression-encoded and stored in the hard disk drive 50.

Further, the hierarchical data generation unit 106 updates the hierarchical data in the hard disk drive 50 when a need arises to update part of the basic screen, such as when a new window is opened or a window is closed by a user input. Data necessary for updating is acquired from the screen data generation unit 104. In this process, the hierarchical data generation unit 106 preferentially updates an area determined by a rule predefined according to the relation to the current frame (e.g., the currently displayed frame and the neighborhood thereof, or an area predicted to be displayed by the prefetching process).

When the user provides an input requesting enlargement/reduction or scrolling of the screen, the frame area determination unit 108 determines subsequent frame coordinates by computing the amount of movement occurring until the next display update time defined by the frame rate setting. The amount of movement is the amount of movement in the virtual three-dimensional space shown in FIG. 3.

The updated area determination unit 110 determines whether an area that should be updated is included in an area that can be identified from the content of the preceding user input, i.e., in the subsequent frame area determined by the frame area determination unit 108 or the neighborhood thereof, or the area predicted to be displayed immediately. When there is an area that should be updated, the updated area determination unit 110 communicates the identification information of the tile image that covers the area that should be updated to the hierarchical data generation unit 106. The identification information is uniquely assigned to each tile image in advance. The updated area determination unit 110 also communicates the identification information to the loading unit 112, the decoding unit 114, and the displayed image processing unit 116 as needed. This allows the hierarchical data generation unit 106 to update the identified tile image in preference to the other tile images.

The loading unit 112 reads at least part of the tile image forming the hierarchical data generated by the hierarchical data generation unit 106 from the hard disk drive 50 as necessary, and stores the read image in the main memory 60. For example, the loading unit 112 verifies, at a predetermined time interval, whether any of the tile images located within a predetermined range including the tile images used to render the currently displayed frame and tile images located in the higher and lower layers and forming corresponding areas has not been loaded into the main memory 60. If any tile image is identified, the loading unit 112 loads the identified tile image from the hard disk drive 50.

If the tile image already loaded into the main memory 60 covers the area that should be updated in response to the user request, the loading unit 112 acquires the identification information of the tile image from the updated area determination unit 110, and loads the data for the tile image updated by the hierarchical data generation unit 106 from the hard disk drive 50 for a second time. The process may be performed by allowing the hierarchical data generation unit 106 to directly overwrite the data for the relevant tile image stored in the main memory 60.

The decoding unit 114 reads part of the tile image data from the main memory 60, decodes the read data, and stores the decoded data in the buffer memory 70. The tile images subject to decoding are tile image located within a predetermined range including the current frame area. By decoding image data over a broad range and storing the decoded data in the buffer memory 70, the frequency of reading from the main memory 60 is reduced and smooth frame motion is achieved. The buffer memory 70 may be configured as a double buffer so that the area predicted by the prefetch process is decoded and stored therein.

If any of the decoded tile images stored in the buffer memory 70 covers the area that should be updated according to a user request, the decoding unit 114 acquires the identification information of the tile image from the updated area determination unit 110. The decoding unit 114 reads the updated data for the tile image from the main memory 60 and decodes the data for a second time.

The displayed image processing unit 116 reads image data covering the frame area from the buffer memory 70 and renders the frame in the frame memory of the display processing unit 44. While the user is requesting scrolling or enlargement/reduction of the screen, the displayed image processing unit 116 updates the frame image in accordance with the frame coordinates successively determined by the frame area determination unit 108. Even if the frame coordinates remain unchanged, the displayed image processing unit 116 acquires, in the event that an image within the frame area in the basic screen is updated, information indicating the update from the updated area determination unit 110 and updates the screen by reading the updated image data from the buffer memory 70 for a second time.

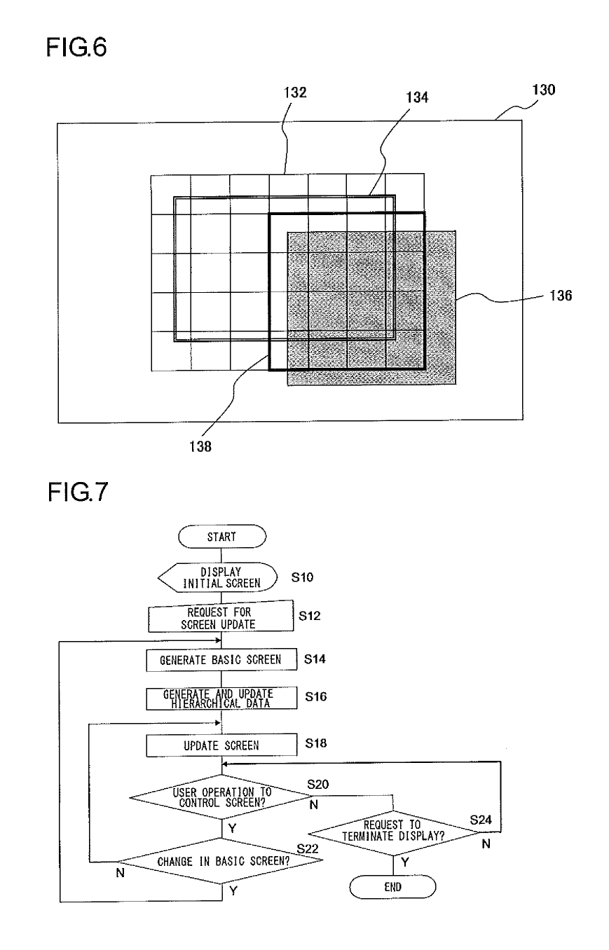

FIG. 6 shows how a tile image is updated when part of the basic screen is updated. Referring to the figure, the outermost rectangular area 130 represents the basic screen generated by the screen data generation unit 104. The hierarchical data generated by the hierarchical data generation unit 106 comprises image data representing the basic screen, which is represented by the area 130, in a plurality of resolutions. It will be assumed that a rectangular area 134 indicated by double lines inside the area 130 representing the basic screen is the current frame area. In other words, the area 134 of the basic screen represented by the area 130 is shown on an enlarged scale.

When part of the basic screen is updated according to the user request, the area for which the tile image should be updated preferentially is defined as indicated by an area 132 comprising a plurality of blocks. In the illustrated example, the area is defined as an area comprising tile images covering the current frame area 134.

Each of the blocks forming the area 132 represents a tile image. In the figure, partitions of tile images are shown only in the area 132. However, the entire area that originates hierarchical data, i.e., the area 130 representing the basic screen, is partitioned by tile images each assigned identification information.

The rule to determine an area for which image data is updated preferentially is not limited to the one described above. For example, the area for which the data is stored in the buffer memory, or the area loaded into the main memory 60, or the area predicted to be displayed may be preferentially updated. In any case, a rule should be established to estimate an area that is highly likely to be needed based on current and past frame areas. An area determined as described above will be referred to as an “active area”.

A case will be considered in which a need arises to update a hatched area 136, which is part of the basic screen. Of the tile images forming the active area 132, the updated area determination unit 110 detects tile images covering the area 136, which should be updated. Referring to the figure, 4×4 tile images located in a solid-lined rectangular area 138 represent such tile images. Detection can be easily done by comparing the active area 132 with the area 136, which should be updated, in the same coordinate system.

The updated area determination unit 110 communicates the identification information of the detected tile images to the hierarchical data generation unit 106, the loading unit 112, the decoding unit 114, and the displayed image processing unit 116. This allows the hierarchical data for the detected tile images stored in the hard disk drive 50 to be updated, allows the tile image data in the main memory 60 to be updated, allows the decoded data in the buffer memory 70 to be updated, and allows the screen to be updated accordingly. It should be noted that, once the tile images in the active area have been updated, the other tile images that should be updated are successively updated. For this purpose, the updated area determination unit 110 communicates to the hierarchical data generation unit 106 the identification information of the tile images outside the active area that should be updated.

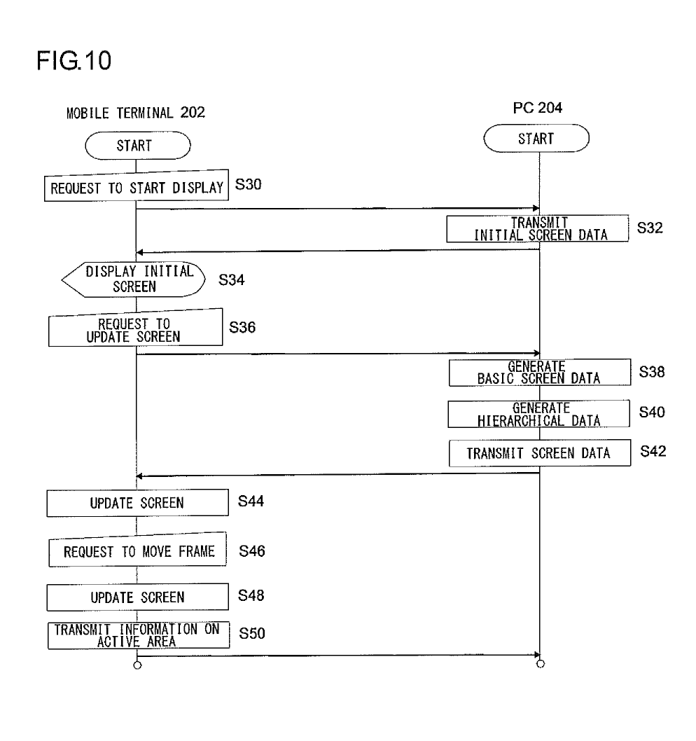

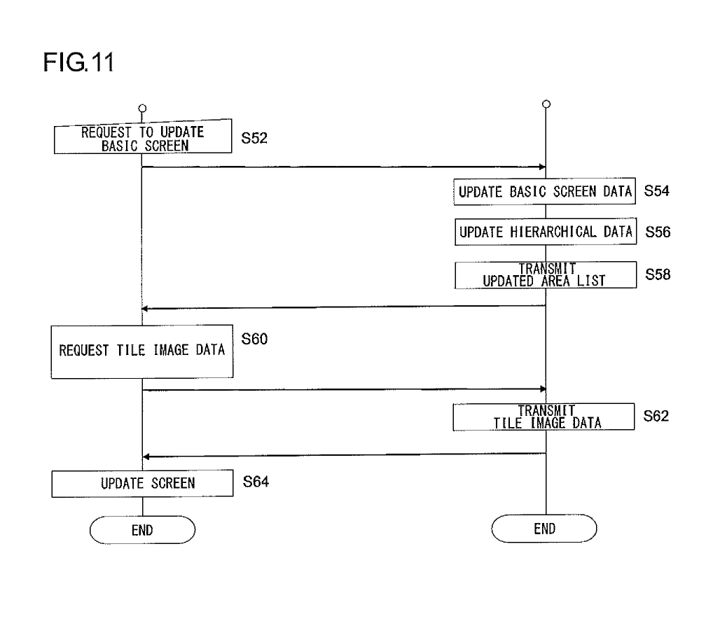

A description will now be given of the operation of the information processing device 10 implemented by the above-described configuration. FIG. 7 is a flowchart showing the steps for displaying a screen according to the first embodiment. Referring to the flowchart shown in FIG. 7 and the sequence chart shown in FIGS. 10 and 11, the steps in the respective components are denoted by a combination of S (initial letter of Step), which indicates “step”, and a numeral. When a determination is made in a step denoted by a combination of S and a numeral in the flowchart of this specification and when the result of determination is affirmative, Y (initial letter of Yes) is used to indicate the affirmative determination (e.g., Y in S10). Conversely, when the result of determination is negative, N (initial letter of No) is used to indicate the negative determination (e.g., N in S10).

The process in the flowchart of FIG. 7 is started when the user provides an input to start displaying a screen to the information processing device 10. The information processing device 10 displays an initial screen on the display device 12 by loading the data for an initial screen from the hard disk drive 50, decoding the loaded data, and rendering the screen (S10). The initial screen data may not be hierarchical data. Whether to configure the initial screen data as hierarchical data may be determined as appropriate depending on whether to accept a request for enlargement or reduction.

When the user provides an input to request updating of the screen (e.g., request to display a screen other than the initial screen) by, for example, controlling a cursor displayed in the initial screen using the input device (S12), the screen data generation unit 104 generates a new screen in which images forming the screen and acquired from the hard disk drive 50 or the information provider server 5 are arranged (S14). For example, the screen data generation unit 104 generates data for a screen in which an icon, tool bar, and cursor are laid over the background image. The resultant screen represents a basic screen.

Thereupon, the hierarchical data generation unit 106 generates hierarchical data by generating a plurality of pieces of image data representing the basic screen in predetermined resolutions and stores the generated data in the hard disk drive 50 (S16). The display screen is updated from the initial screen to the basic screen through coordinated processing in the loading unit 112, the decoding unit 114, and the displayed image processing unit 116 (S18).

The system stands by the next input by the user in this state (N in S20, N in S24).

When the user controls the screen in some way via the input device 20 (Y in S20) and the control creates a need to update the basic screen (Y in S22), the screen data generation unit 104 generates data for a screen in which is arranged an image necessary for updating and acquired newly (S14). The hierarchical data generation unit 106 updates the data for a tile image subject to updating (S16). In this process, tile images included in the active area detected by the updated area determination unit 110 are updated preferentially.

The loading unit 112 and the decoding unit 114 load and decode the tile image subject to updating, respectively, so that the display image processing unit 116 updates the screen accordingly (S18). Meanwhile, when the user controls the screen in some way via the input device 20 (Y in S20) and the control does not update the basic screen but requires scrolling or enlarging/reducing the screen (N in S22), the screen is updated as the frame area determination unit 108 successively determines frame coordinates and the displayed image processing unit 116 renders frames accordingly (S18).

When an area not decoded and so not stored in the buffer memory 70 is found in the new frame area, or when there is a tile image not stored in the main memory 60, the decoding unit 114 and the loading unit 112 process the subject area appropriately. When there is not any user input to control the screen (N in S20) and when a user input to terminate the display is provided (Y in S24), the display process is terminated.

According to the first embodiment described above, the image of the screen in which the displayed content is changed by the user is generated as hierarchical data on a realtime basis. This achieves efficient response to a user request to scroll or enlarge/reduce the screen regardless of the type, count, layout, etc. of images displayed in the screen. For example, in the case of an image showing a document using a document viewer application, the inventive approach has an edge over the related technology, which selects and displays a font from the original text data, because the inventive approach processes characters as images and so enables enlargement/reduction that does not rely on maintaining font data of proper size or using an alternative font.

Further, when a need arises to partially update the basic screen such as when a new window is opened or when application processing proceeds, the screen is updated efficiently by updating only the data for a tile image in an area that should be updated. By preferentially updating an area that is highly likely to be displayed, which can be identified based on the current frame area, the likelihood of occurrence of a delay in outputting a screen due to an update to the hierarchical data is reduced.

### Second Embodiment

The first embodiment as described relates to display process performed in a single information processing device 10. In this embodiment, the inventive approach is applied to remote display technology whereby the screen output by an information processing device is displayed on a remote display of another display system connected to a network such as a gigabit Ethernet (registered trademark) network instead of displaying the screen on a display device directly connected to the information processing device. The technology is described in detail in a published Japanese patent application JP2010-20159 filed by us.

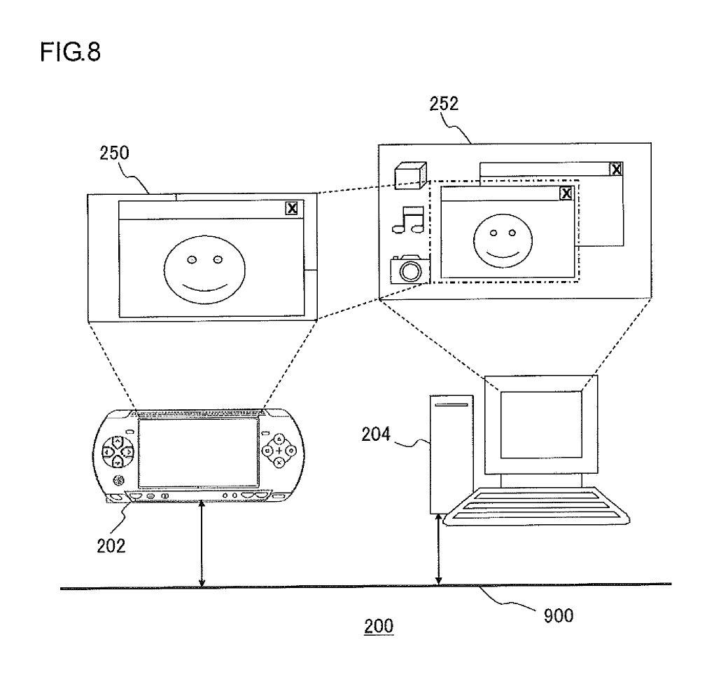

FIG. 8 shows the configuration of an on-screen display system according to the second embodiment. The figure shows an example where a PC 204 connected to a network 900 in the on-screen display system 200 displays a screen on a mobile terminal 202 also connected to the network 900. The PC 204 receives data for a graphical user interface (GUI) from the mobile terminal 202 and emulates a keyboard/mouse command accordingly. The GUI date includes a command provided via the GUI to control a window or an icon displayed on the display of the mobile terminal 202.

The PC 204 emulates a keyboard or mouse operation based on the GUI data received from the mobile terminal 202 so as to generate a signal that will be generated in association with the operation. This generates screen data as if an input device such as a keyboard or mouse connected to the PC 204 is used to initiate the operation. The PC 204 compression-encodes the screen data thus generated and transmits the resultant data to the mobile terminal 202.

In this embodiment, the PC 204 generates and maintains hierarchical data. The PC 204 transmits a necessary tile image to the mobile terminal 202 in accordance with a request input by the user in the mobile terminal 202 requesting scrolling or enlargement/reduction of the screen. As a result, the data for a basic screen 252 is generated realtime in the PC 204 in accordance with a user request. A screen 250, which represents at least part of the screen 252, is displayed on the display of the mobile terminal 202.

FIG. 9 shows the configuration of the mobile terminal 202 and the PC 204 in detail. The figure only shows functional blocks related to image display technology described in the second embodiment. As in the first embodiment, the mobile terminal 202 and the PC 204 may perform processes other than those described above; functional blocks created in association with those processes are omitted from the illustration.

The mobile terminal 202 comprises an input device 206 configured to receive a user input, an input information acquisition unit 208 configured to acquire information related to an operation initiated by the user using the input unit 206, a GUI data transmitter unit 210 configured to transmit GUI data to the PC 204, a frame area determination unit 212 configured to successively determine a frame area that should be displayed, a data request unit 214 configured to request image data necessary to render a frame from the PC 24, and an updated area list storage 215 configured to store information on an area that should be updated. Information on an area that should be updated represents, for example, a list of identification information of tile images that should be updated. Hereinafter, the list will be referred to as “updated area list”.

The mobile terminal 202 further comprises a data receiver unit 216 configured to receive image data transmitted from the PC 204, a decoding unit 218 configured to decode image data, a buffer memory 220 configured to store decoded image data, and a displayed image processing unit 222 configured to render a displayed image, and a display unit 224 configured to display a screen.

Meanwhile, the PC 204 comprises an emulation unit 226 configured to emulate the GUI data transmitted from the mobile terminal 202, a screen data generation unit 228 configured to generate data for a basic screen in accordance with an operation performed in the mobile terminal 202, a hierarchical data generation unit 232 configured to generate hierarchical data from the screen data, an updated area determination unit 234 configured to determine an area that should be updated, a transmitter unit 236 configured to transmit image data in accordance with a request from the mobile terminal 202, and a hard disk drive 230 configured to store the generated hierarchical data. Like the information processing device 10 according to the first embodiment, the PC 204 may further comprise a main memory (not shown).

The input unit 206, the input information acquisition unit 208, and the frame area determination unit 212 of the mobile terminal 202 have the same functions as the input device 20, the input information acquisition unit 102, and the frame area determination unit 108 according to the first embodiment, respectively. However, information on a command input that will trigger the updating of the basic screen is transmitted from the input information acquisition unit 208 to the GUI data transmitter unit 210. The GUI data transmitter unit 210 transmits the information to the PC 204.

When a new tile image is necessary to display a screen in the mobile terminal 202, the data request unit 214 requests the image data by transmitting identification information of the tile image to the PC 204. Requirement for a new tile image arises when a tile image other than the tile images already stored in the buffer memory 220 or a memory (not shown) is needed or when the tile image already stored is subject to updating. In order to detect whether the stored tile image is subject to updating, the data request unit 214 refers to the updated area list storage 215 at a certain timing schedule (e.g., when the user initiates an operation to control the screen) to verify whether the identification information of the stored tile image is included in the updated area list.

Requirement for a tile image other than the stored tile image arises when the frame is moved due to a user operation so that an area outside the stored tile images is entered, or when the area outside the stored tile images is predicted to be entered. The method of determining a target tile image may be similar to the method of determining a target of loading by the loading unit 112 according to the first embodiment into the main memory 60, or the method of determining a tile image subject to decoding by the decoding unit 114.

The data request unit 214 further determines an active area each time the frame is moved by referring to the frame coordinates. The data request unit 214 transmits the information on determination to the PC 204. As described in the first embodiment, an active area is determined according to a predefined rule by referring to the current frame and the past route of movement of the frame.

The data receiver unit 216 receives data for a tile image transmitted from the PC 204 and supplies the data to the decoding unit 218. Alternatively, the data receiver unit 216 may temporarily store the image in a memory (not shown) as in the first embodiment. The decoding unit 218, the buffer memory 220, the displayed image processing unit 222, and the display unit 224 operate the same way as the decoding unit 114, the buffer memory 70, the displayed image processing unit 116, and the display device 12, in the first embodiment, respectively.

The emulation unit 226 of the PC 204 receives GUI data from the mobile terminal 202 and generates a request signal that is valid inside the PC 204. This allows an icon to be selected, a file to be opened, a web page to be displayed, application processing to proceed, etc. in the PC 204 in accordance with the operation initiated in the mobile terminal 202. The screen data generation unit 228, the hierarchical data generation unit 232, and the updated area determination unit 234 function in the same way as the screen data generation unit 104, the hierarchical data generation unit 106, and the updated area determination unit 110 according to the first embodiment, respectively.

The difference is that the updated area determination unit 234 receives information related to the active area from the mobile terminal 202 and determines the tile image that should be updated preferentially. The updated area determination unit 234 transmits the identification information to the mobile terminal 202 in the form of an updated area list. In response to a request for image data transmitted from the data request unit 214 of the mobile terminal 202, the data transmitter unit 236 reads the latest data for the requested tile image and transmits the read data to the mobile terminal 202.

A description will now be given of the operation of the on-screen display system implemented by the above-described configuration. FIGS. 10 and 11 are sequence charts showing the steps of displaying a screen according to the second embodiment. Elapse of time is omitted from the illustration for simplicity. The steps performed in the mobile terminal 202 are not limited to those illustrated. The process of the sequence chart is started when the user provides an instruction to start displaying a screen in the mobile terminal 202. When the user provides an input to start display a screen (S30), the GUI data transmitter unit 210 transmits the associated information to the PC 204, and the data transmitter unit 236 of the PC 204 returns data for an initial screen (S32).

In response, the mobile terminal 202 displays the initial screen on the display by decoding the transmitted data for the initial screen and rendering the screen (S34). When the user provides an input to request updating of the screen (e.g., request to display a screen other than the initial screen) by, for example, controlling a cursor displayed in the initial screen (S36), the associated information is transmitted to the PC 204. The screen data generation unit 228 generates data for a basic screen in which images forming the screen and acquired from the hard disk drive 230 or the information provider server 5 are arranged (S38).

Thereupon, the hierarchical data generation unit 232 generates hierarchical data by generating a plurality of pieces of image data representing the basic screen in predetermined resolutions and stores the generated data in the hard disk drive 230 (S40). The data transmitter unit 236 transmits the data for tile images included in the generated hierarchical data to the mobile terminal 202 (S42). Tile images transmitted in S42 may be variably determined. For example, the tile images in the 0-th layer, which is characterized by the lowest resolution, may be transmitted so that the perspective of the entire basic screen is gained.

The display screen is updated in the mobile terminal 202 from the initial screen to the basic screen through the coordinated steps performed in the data receiver unit 216, the decoding unit 218, the displayed image processing unit 222 (S44). When the user provides an input requesting the movement of the frame, i.e., requesting scrolling or enlargement/reduction of the screen (S46), the frame area determination unit 212 successively determines frame coordinates, and the displayed image processing unit 222 renders a new frame, Thereby, the display screen is updated (S48). In this process, new image data is acquired from the PC 204 as necessary, and the decoded data is stored in the buffer memory 220 and used in rendering, as described above.

When the frame area is moved as described above, the data request unit 214 of the mobile terminal 202 derives a new active area in adaptation to the frame area and transmits the relevant information to the PC 204 (S50).

Referring to FIG. 11, when the user provides an input requesting the updating of the basic screen (S52), the relevant information is transmitted to the PC 204, and the screen data generation unit 228 updates the data for the basic screen by, for example, acquiring a new image necessary for updating (S54). The hierarchical data generation unit 232 updates the data for a tile image subject to updating (S56). In this process, the updated area determination unit 234 detects a tile image included in the active area transmitted from the mobile terminal 202 and updates the tile image preferentially.

The updated area determination unit 234 further transmits the identification information of the tile image thus updated to the mobile terminal 202 in the form of an updated area list (S58). When a new tile image is needed, or when the identification information of a tile image stored in the buffer memory 202 is included in the updated area list, the data request unit 214 of the mobile terminal 202 requests image data by transmitting the identification information of the target tile image to the PC 204 (S60).

The data transmitter unit 236 of the PC 204 reads the data for the requested tile image from the hard disk drive 230 and transmits the data to the mobile terminal 202 (S62). When the data receiver unit 216 of the mobile terminal 202 receives the data, the decoding unit 218 decodes the data and the displayed image processing unit 222 renders the frame so that the display screen is updated accordingly (S64).

When a mouse pointer is displayed in the mobile terminal 202 and the user provides an input using the pointer, the PC 204 may also display the mouse pointer in the basic screen, coordinating the movement. In this case, however, the image of the mouse pointer is excluded from the image of the generated hierarchical data. Only the information on the position of the mouse pointer is used to interpret an input command. Meanwhile, the mouse pointer may not be displayed in the PC 204 so that only the information related to the control of the mouse pointer in the mobile terminal 202 is transmitted to the PC 204. In any case, the image of the mouse pointer is overlaid in the screen when it is displayed in the mobile terminal 202.

In the image display system according to the second embodiment described above, a user operation in a mobile terminal is processed in a PC and the resultant display screen is displayed in a mobile terminal. The image of the basic screen that changes according to user operation is generated in the form of hierarchical data and stored in the PC. This achieves efficient response to a user request to scroll or enlarge/reduce the screen regardless of the type, count, layout, etc. of images displayed in the screen.

When the basic screen is partially updated, the mobile terminal detects an area that is found in the area determined as being highly likely to be displayed based on the current frame area and that is updated. The mobile terminal requests the detected area from the PC. In this way, only the necessary image data is efficiently acquired so that the screen is updated efficiently while reducing consumption of resources such as memories.

Described above is an explanation based on an exemplary embodiment. The embodiment is intended to be illustrative only and it will be obvious to those skilled in the art that various modifications to constituting elements and processes could be developed and that such modifications are also within the scope of the present invention.

What is claimed is:

1. A screen output device comprising:
an input information acquisition unit configured to acquire information related to user input provided in an input device;
a screen data generation unit configured to generate data for a basic screen in which images that should be displayed in response to user input are arranged;
a hierarchical data generation unit configured to generate hierarchical data formed as a hierarchy of a plurality of pieces of image data representing the basic screen in a plurality of resolutions and arranged in the order of resolution; and
a displayed image processing unit configured to switch between data among the hierarchical data and to use the selected data to generate an output screen in accordance with user input of a type requesting scrolling or enlargement/reduction of the screen,
wherein the hierarchical data generation unit updates, in response to user input to update at least part of the basic screen, a relevant area in the hierarchical data.

2. The screen output device according to claim 1, further comprising:
an updated area determination unit configured to compare, in response to user input to update at least part of the basic screen, an active area within a predetermined range in the basic screen including an area of the output screen with an area to be updated, defines the area to be updated and that is included in the active area as a preferentially updated area, and communicates information on the preferentially updated area to the hierarchical data generation unit, and
wherein the hierarchical data generation unit updates the preferentially updated area in the hierarchical data with higher priority than the other areas.

3. The screen output device according to claim 2,
wherein the updated area determination unit communicates the information on the preferentially updated area to the displayed image processing unit, and the displayed image processing unit updates a portion in the output screen subject to updating by referring to the information on the preferentially updated area.

4. The screen output device according to claim 2, further comprising:
a buffer memory configured to store data derived from decoding image data forming the hierarchical data and corresponding to the active area,
wherein the displayed image processing unit reads image data that is stored in the buffer memory and that defines the area of the output screen, and generates the output screen accordingly.

5. The screen output device according to claim 1,
wherein the input information acquisition unit acquires information related to a user input provided via graphical user interface included in the basic screen, and
the hierarchical data generation unit updates the hierarchical data for the updated basic screen by acquiring image data to be displayed in response to the user input from the screen data generation unit.

6. A screen output system comprising a user terminal operated by a user and provided with a display, and an information processing device receiving information on user operation in the user terminal via a network and transmitting image data for a screen to be displayed on the display to the user terminal,
wherein the information processing device comprises:
a screen data generation unit configured to generate data for a basic screen in which images to be displayed in response to the user operation are arranged; and
a hierarchical data generation unit configured to generate hierarchical data formed as a hierarchy of a plurality of pieces of image data representing the basic screen in a plurality of resolutions and arranged in the order of resolution,
wherein the user terminal comprises:
a data request unit configured to designate, from a plurality of data blocks forming the hierarchical data, a data block determined in accordance with an area of an output screen changed in response to a request, provided via the operation, to scroll, enlarge, or reduce the screen, and to request relevant image data from the information processing device, and
a displayed image processing unit configured to use the image data transmitted from the information processing device in response to the request so as to generate an output screen that is displayed on the display,
wherein the hierarchical data generation unit updates, in response to the operation to update at least part of the basic screen, a relevant area in the hierarchical data.

7. The screen output system according to claim 6,
wherein the information processing device further comprises:
an updated area determination unit configured to compare, in response to the operation to update at least part of the basic screen, an active area within a predetermined range in the basic screen including an area of the output screen with an area to be updated, to define the area to be updated that is included in the active area as a preferentially updated area, and to communicate information on the preferentially updated area to the hierarchical data generation unit, and
wherein the hierarchical data generation unit updates the preferentially updated area in the hierarchical data with higher priority than the other areas.

8. The screen output system according to claim 7,
wherein the updated area determination unit communicates the information on the preferentially updated area to the user terminal,
the data request unit of the user terminal designates, when the image data transmitted from the information processing device in the past includes data for the preferentially updated area, a relevant data block and requests relevant image data from the information processing device, and
the displayed image processing unit uses the image data newly transmitted so as to generate an output screen displayed on the display device.

9. The screen output system according to claim 7,
wherein the updated area determination unit acquires information on the active area when the area of the output screen is changed in response to user input provided via the operation and request scrolling, enlargement, or reduction of the screen.

10. The screen output system according to claim 6,
wherein the user terminal comprises:
an input information acquisition unit configured to acquire information related to user input provided via a graphical user interface included in the basic screen;
the hierarchical data generation unit of the information processing device updates the hierarchical data for the updated basic screen by acquiring image data to be displayed in response to the user input from the screen data generation unit.

11. A screen output method comprising:
acquiring information related to user input provided in an input device;
generating data for a basic screen in which images to be displayed in response to the user input are arranged;
generating hierarchical data formed as a hierarchy of a plurality of pieces of image data representing the basic screen in a plurality of resolutions and arranged in the order of resolution;
updating, in response to user input to update at least part of the basic screen, a relevant area in the hierarchical data; and
switching between data in the hierarchical data and using the selected data to generate an output screen in accordance with a user input of a type requesting scrolling or enlargement/reduction of the screen.

12. A screen output method adapted to a system where an information processing device connected to a network generates image data for a screen in response to a user operation in a user terminal also connected to the network, causing a display of the user terminal to display the screen,
the method comprising, in the information processing device:
generating data for a basic screen in which images to be displayed in response to the user operation are arranged;
generating hierarchical data formed as a hierarchy of a plurality of pieces of image data representing the basic screen in a plurality of resolutions and arranged in the order of resolution; and
updating, in response to the operation to update at least part of the basic screen, a relevant area in the hierarchical data, and
the method further comprising, in the user terminal;
designating, from a plurality of data blocks forming the hierarchical data, a data block determined in accordance with an area of an output screen changed in response to a request, provided via the operation, to scroll, enlarge, or reduce the screen, and requesting relevant image data from the information processing device; and
using the image data transmitted from the information processing device in response to the request so as to generate an output screen that is displayed on the display.

13. A computer program embedded in a non-transitory computer-readable recording medium, comprising:
a module configured to acquire information related to user input provided in an input device;
a module configured to generate data for a basic screen in which images to be displayed in response to the user input are arranged;
a module configured to generate hierarchical data formed as a hierarchy of a plurality of pieces of image data representing the basic screen in a plurality of resolutions and arranged in order of resolution;
a module configured to update, in response to user input to update at least part of the basic screen, a relevant area in the hierarchical data; and
a module configured to switch between data in the hierarchical data and to use the selected data to generate an output screen in accordance with user input of a type requesting scrolling or enlargement/reduction of the screen.

14. A computer program embedded in a non-transitory computer-readable recording medium, the program being adapted to transmit image data for a screen to be displayed on a display of a user terminal connected to a network, in response to user operation in the user terminal, the program comprising:
a module configured to generate data for a basic screen in which images to be displayed in response to the user operation are arranged;
a module configured to generate hierarchical data formed as a hierarchy of a plurality of pieces of image data representing the basic screen in a plurality of resolutions and arranged in order of resolution;
a module configured to update, in response to the operation to update at least part of the basic screen, a relevant area in the hierarchical data; and
a module configured to acknowledge designation of a data block selected among a plurality of data blocks forming the hierarchical data in accordance with an area of an output screen changed in response to a request, provided via the operation, to scroll, enlarge, or reduce the screen, and transmitting the designated image data to the user terminal.

15. A non-transitory computer-readable recording medium having embodied thereon a computer program comprising:
a module configured to acquire information related to user input provided in an input device;
a module configured to generate data for a basic screen in which images to be displayed in response to the user input are arranged;
a module configured to generate hierarchical data formed as a hierarchy of a plurality of pieces of image data representing the basic screen in a plurality of resolutions and arranged in order of resolution;
a module configured to update, in response to user input to update at least part of the basic screen, a relevant area in the hierarchical data; and
a module configured to switch between data in the hierarchical data and to use the selected data to generate an output screen in accordance with a user input of a type requesting scrolling or enlargement/reduction of the screen.

16. A non-transitory computer-readable recording medium having embodied thereon a program adapted to transmit image data for a screen to be displayed on a display of a user terminal connected to a network, in response to user operation in the user terminal, the program comprising:
a module configured to generate data for a basic screen in which images to be displayed in response to the user operation are arranged;
a module configured to generate hierarchical data formed as a hierarchy of a plurality of pieces of image data representing the basic screen in a plurality of resolutions and arranged in order of resolution;
a module configured to update, in response to the operation to update at least part of the basic screen, a relevant area in the hierarchical data; and
a module configured to acknowledge designation of a data block selected among a plurality of data blocks forming the hierarchical data in accordance with an area of an output screen changed in response to a request, provided via the operation, to scroll, enlarge, or reduce the screen, and transmitting the designated image data to the user terminal.
